(19) United States
(12) Patent Application Publication
(10) Pub. No.: US 2007/0141192 A1
(43) Pub. Date: Jun. 21, 2007

(54) MOLDING APPARATUS

(75) Inventor: MING-CHIANG TSAI, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Taipei Hsien (TW)

(21) Appl. No.: 11/309,664

(22) Filed: Sep. 7, 2006

(30) Foreign Application Priority Data
Dec. 16, 2005 (CN) 200510120670.8

(51) Int. Cl. B29D 11/00; B29C 43/36

(52) U.S. Cl. 425/395; 425/808

(57) ABSTRACT

A molding apparatus (200) includes a fixed molding unit (210), a movable molding unit (220), and a guiding sleeve (230). The fixed molding unit includes a first columnar element (212) having a first forming face (226) at a first end (224) thereof. The movable molding unit includes a second columnar element (222) having a second forming face (216) facing the first forming face at a second end (214) thereof. The guiding sleeve defines a guiding through-hole (234) and an opening (232) communicating with the guiding through-hole. The guiding through-hole is configured for receiving and centering the two ends therein. The opening is configured for exposing the ends when the molding apparatus is assembled.

### FIELD OF THE INVENTION

The present invention relates to molding apparatuses and, more particularly, relates to a molding apparatus with a precise concentricity.

### DESCRIPTION OF RELATED ART

Molding apparatuses are critical to modern industry. One set of designed molding apparatuses can be used many thousands of times to manufacture thousands of products. However, if the molding apparatus is badly designed, this can affect the quality of the products produced. Generally, accuracy in obtaining desirable characteristics of the products, such as concentricity, rests with the manufacturing precision and the assembling precision of the molding apparatus.

Referring to FIG. 4, a currently available molding apparatus 100 mainly includes a fixed molding unit 110 and a movable molding unit 120 facing the fixed molding unit 110. A forming face 114 is defined by a mold surface 112 of the fixed molding unit 110. The forming face 114 is generally a concave surface, either spherical or aspherical, depending on the lens being produced. A forming face 126 is similarly defined by a mold surface 122 of the movable molding unit 120. The forming face 126 is generally a convex (e.g., spherical or aspherical) surface. A plurality of engaging holes 116 are formed in the mold surface 112 of the fixed molding unit 110. A plurality of locating pins 127 is formed on the mold surface 122 of the movable molding unit 120. Each locating pin 127 is opposite to and can engage with a corresponding one of the engaging holes 116, so that the concentricity of the molding apparatus 100, as well as the forming faces 114 and 126, can be ensured via engagement of the locating pins 127 and the corresponding engaging holes 116.

Also, referring to FIG. 5, when the molding apparatus 100 is assembled, a forming cavity 130 is defined by the molding apparatus 100. The forming cavity 130 is configured for having a molding material injected thereinto and thereby forming a product 140 such as an optical lens. The product 140 can have a good concentricity because of the engagement of the locating pins 127 and the engaging holes 116.

However, after long-term usage of the molding apparatus 100 and engagement between the locating pins 127 and the engaging holes 116, the locating pins 127 and/or the engaging holes 116 are prone to significant wear. Such wear can reduce the precision of the molding apparatus 100, and the concentricity of the product 140 is accordingly affected.

What is needed, therefore, is a molding apparatus that can produce a greater number of products with constant and accurate concentricity and/or precision.

### SUMMARY OF THE INVENTION

A molding apparatus according to an embodiment includes a fixed molding unit, a movable molding unit, and a guiding sleeve. The fixed molding unit includes a first columnar element having a first forming face at a first end thereof. The movable molding unit includes a second columnar element having a second forming face facing the first forming face at a second end thereof. The guiding sleeve defines a guiding through-hole and an opening communicating with the guiding through-hole. The guiding through-hole is configured for receiving and centering the two ends therein. The opening is configured for exposing the two ends when the molding apparatus is assembled.

Other advantages and novel features will become more apparent from the following detailed description of the present molding apparatus, when taken in conjunction with the accompanying drawings.

### BRIEF DESCRIPTION OF THE DRAWINGS

Many aspects of the present molding apparatus can be better understood with reference to the following drawings. The components in the drawings are not necessarily drawn to scale, the emphasis instead being placed upon clearly illustrating the principles of the present molding apparatus. Moreover, in the drawings, like reference numerals designate corresponding parts throughout the several views.

FIG. 1 is a schematic, plan view of a molding apparatus, in accordance with a preferred embodiment, showing the molding apparatus in an assembled state;

FIG. 2 is a schematic, plan view of the molding apparatus of FIG. 1 in a disassembled state;

FIG. 3 is a schematic, cross-sectional view of a product formed by the molding apparatus of FIG. 1;

FIG. 4 is a schematic, cross-sectional view of a currently available molding apparatus in a disassembled state; and

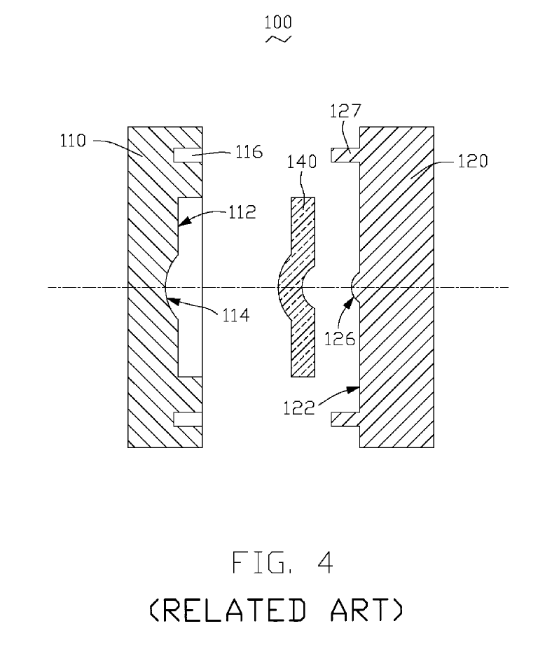

FIG. 5 is a schematic, cross-sectional view of the molding apparatus of FIG. 4 in an assembled state.

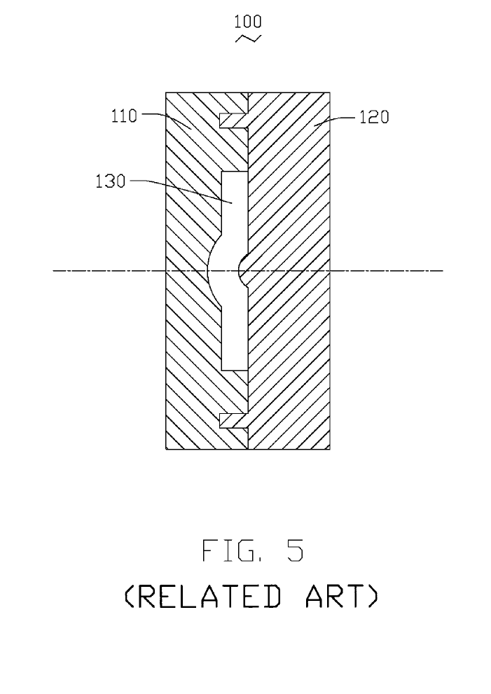

### DETAILED DESCRIPTION OF THE INVENTION

Reference will now be made to the drawings to describe a preferred embodiment of the present molding apparatus, in detail.

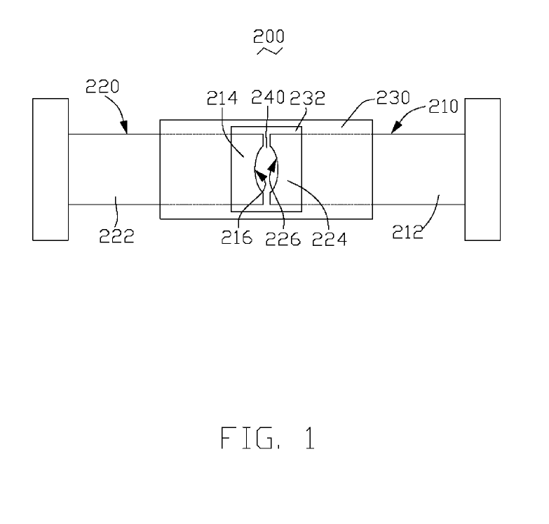

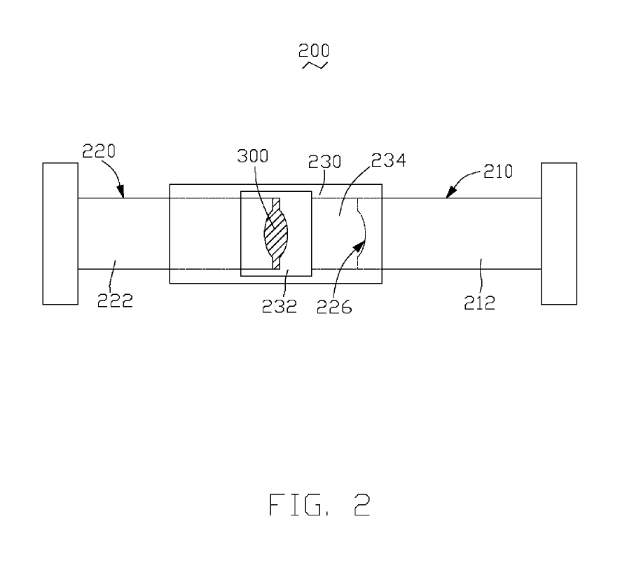

Referring to FIGS. 1 and 2, a molding apparatus 200, in accordance with a preferred embodiment, includes a fixed molding unit 210, a movable molding unit 220 facing the fixed molding unit 210, and a guiding sleeve 230. The molding apparatus 200 can include, alternatively or additionally, other components known in the art and should not necessarily be restricted by FIGS. 1 and 2.

The fixed molding unit 210 includes a columnar element 212. A forming face 226 is defined by an end 224 of the fixed molding unit 210. The forming face 226 can advantageously be a concave surface, either spherical or aspherical depending on the shape/configuration desired for the object being molded thereby. The movable molding unit 220 also includes a columnar element 222. A forming face 216 is defined by an end 214 of the movable molding unit 220. The forming face 216 is shown to be a concave surface, in a manner similar to the forming face 226 (i.e., one of spherical and aspherical). Consistent with the nature of molds in general, it is understood that at least one of forming faces 216, 226 needs to be concave, at least in part. However, depending on the contour desired for the molded product, it is to be understood that one face 216, 226 could instead be convex and still be within the scope of molding apparatus 200. It is also to be understood that the fixed molding unit 210 could also be movable and still be within the scope of the present molding apparatus 200.

The guiding sleeve 230 defines a lengthwise guiding through-hole 234 (referring to FIG. 2) configured for receiving and centering the two columnar elements 212, 222 therein. The guiding sleeve 230 further defines an opening 232 transversely communicating with the guiding through-hole 234 and is configured for exposing the two ends 224, 214, in order to allow/facilitate for their use in a molding procedure. Preferably, the opening 232 is located at the middle section of the guiding sleeve 230. The opening 232 can either be open only at a side of the guiding sleeve 230 or open through opposing sides (i.e., a through opening) of the guiding sleeve 230 (i.e., a portion of the guiding sleeve 230, proximate the opening 232, must remain in order to interconnect the opposing ends of the guiding sleeve 230). The guiding sleeve 230 can be fixed on the columnar element 222 and can movably engage with the columnar element 212. Alternatively, the guiding sleeve 230 can movably engage with the columnar elements 212, 222.

It is to be understood that the cross-sectional shapes of the columnar elements 212, 222 will be particularly chosen to matingly correspond with that of the guiding through-hole 234 so as to produce a close clearance fit. Such a close clearance fit will beneficially permit the columnar elements 212, 222 to easily slide within the guiding sleeve 230 but, at the same time, will ensure the desired alignment of the forming faces 216, 226 relative to one another. Further, it is understood that a circular or oval cross-section for such members would provide no sharp corners and, thus, would tend to contribute less to wear and/or failure (i.e., sharp corners act as stress concentrators and as abrasion sites).

However, it is to be understood that, certain cross-sections may prove to be particularly appropriate. In situations where the product will not have rotational symmetry, it may be useful to employ a polygonal cross-section to minimize the opportunity for rotation between the forming faces 216, 226. In this regard, where relative rotation should be avoided, an oval cross-section may prove to be the most advantageous, avoiding both sharp corners and tending to prevent relative rotation between the forming faces 216, 226. In situations where complete rotational symmetry in the product is desirable, a circular cross-section would promote precise concentricity (no matter the rotational angular position of the forming faces 216, 226), would not promote wear, and would generally be readily formed and/or machined.

When the molding apparatus 200 is assembled, a forming cavity 240 is defined by the two forming faces 216, 226. The forming cavity 240 is configured for receiving a molding material thereinto and forming a product 300, such as an optical lens. The product 300 can be taken out through the opening 232.

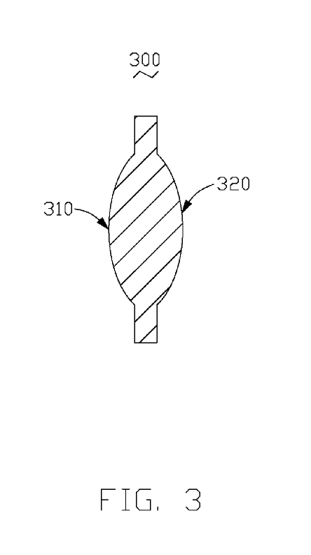

Referring to FIG. 3, the product 300 includes two side surfaces 310, 320. Shapes of two side surfaces 310, 320, respectively, conform to the two forming faces 216, 226. Because the concentricity of the two forming faces 216 can be maintained by the guiding sleeve 230, the side surfaces 310, 320 also can maintain a good alignment/concentricity. Particularly, a precise concentricity of the molding apparatus 200 can be retained even after long-term usage.

It is to be understood that the above-described embodiment is intended to illustrate rather than limit the invention. Variations may be made to the embodiment without departing from the spirit of the invention as claimed. The above-described embodiments are intended to illustrate the scope of the invention and not restrict the scope of the invention.

What is claimed is:

1. A molding apparatus, comprising:
a fixed molding unit comprising a first columnar element, the first columnar element having a first forming face at a first end thereof;
a movable molding unit comprising a second columnar element, the second columnar element having a second forming face at a second end thereof, the second forming face facing the first forming face; and
a guiding sleeve defining a guiding through-hole and an opening communicating with the guiding through-hole, the guiding through-hole being configured for receiving and centering the two ends therein, the opening being configured for exposing the two ends when the molding apparatus is assembled.

2. The molding apparatus as claimed in claim 1, wherein the opening is located at the middle section of the guiding sleeve.

3. The molding apparatus as claimed in claim 1, wherein the opening is at a side of the guiding sleeve.

4. The molding apparatus as claimed in claim 1, wherein the opening is an opening through opposing sides of the guiding sleeve.

5. The molding apparatus as claimed in claim 1, wherein the guiding sleeve is fixed on the second columnar element and movably engages with the first columnar element.

6. The molding apparatus as claimed in claim 1, wherein the guiding sleeve movably engages with the two columnar elements.

7. The molding apparatus as claimed in claim 1, wherein the first columnar element and the second columnar element each have a columnar cross-section, the guiding through-hole having a through-hole cross-section, the columnar cross-section matingly corresponding with the through-hole cross-section.

8. The molding apparatus as claimed in claim 7, wherein the columnar cross-section and the through-hole cross-section are chosen so as to yield a close clearance fit between the guiding through-hole and each of the first columnar element and the second columnar element.

9. A molding apparatus, comprising:
a first molding unit comprising a first extension element, the first extension element having a first forming face at a first end thereof;
a second molding unit comprising a second extension element, the second extension element having a second forming face at a second end thereof, the second forming face facing the first forming face; and
a guiding sleeve defining a guiding through-hole and an opening communicating with the guiding through-hole, the guiding through-hole being configured for receiving and centering the two ends therein, the opening being configured for exposing the two ends when the molding apparatus is assembled.

10. The molding apparatus as claimed in claim 9, wherein the opening is located at the middle section of the guiding sleeve.

11. The molding apparatus as claimed in claim 9, wherein the opening is at a side of the guiding sleeve.

12. The molding apparatus as claimed in claim 9, wherein the opening is an opening through opposing sides of the guiding sleeve.

13. The molding apparatus as claimed in claim 9, wherein the guiding sleeve is fixed on the second extension element and movably engages with the first extension element.

14. The molding apparatus as claimed in claim 9, wherein the guiding sleeve movably engages with the two extension elements.

15. The molding apparatus as claimed in claim 9, wherein the first extension element and the second extension element each have a columnar cross-section, the guiding through-hole having a through-hole cross-section, the columnar cross-section matingly corresponding with the through-hole cross-section.

16. The molding apparatus as claimed in claim 15, wherein the columnar cross-section and the through-hole cross-section are chosen so as to yield a close clearance fit between the guiding through-hole and each of the first columnar element and the second columnar element.

17. The molding apparatus as claimed in claim 9, wherein the first extension element and the second extension element each have a circular, oval or polygonal cross-section, the guiding through-hole having a through-hole cross-section, the circular, oval or polygonal cross-section matingly corresponding with the through-hole cross-section.
